(19) United States
(12) Patent Application Publication
(10) Pub. No.: US 2025/0180451 A1
(43) Pub. Date: Jun. 5, 2025

(54) DEVICE FOR RHEO-ELECTRIC MEASUREMENTS HAVING A LOW THERMAL IMPEDANCE GUARD

(71) Applicant: TA Instruments-Waters LLC, New Castle, DE (US)

(72) Inventors: Scott Merrullo, Philadelphia, PA (US); Nigel Doe, Newark, DE (US)

(21) Appl. No.: 18/961,588

(22) Filed: Nov. 27, 2024

Related U.S. Application Data
(60) Provisional application No. 63/604,289, filed on Nov. 30, 2023.
(60) Provisional application No. 63/560,399, filed on Mar. 1, 2024.

(51) Int. Cl. G01N 3/06; G01N 3/22

(52) U.S. Cl. CPC G01N 3/066; G01N 3/22

(57) ABSTRACT

The present disclosure describes an apparatus for performing electrical and rheology measurements of a material sample, comprising: an upper geometry; and a lower geometry. The lower geometry is stationary and the upper geometry rotates relative to the lower geometry. The lower geometry includes: a first electrode; a second electrode; and an electrical insulator for electrically isolating the first electrode from the second electrode. A thermally conductive metal plate is below the electrical insulator. A layer of low thermal impedance conductive material and a layer of electrically insulating material are between the electrical insulator and the thermally conductive metal plate.

### PRIORITY

This application claims priority to U.S. provisional patent application No. 63/604,289 filed Nov. 30, 2023 and titled “Device for Rheo-Electric Measurements having a Low Thermal Impedance Guard” and U.S. Provisional Patent Application Ser. No. 63/560,399 filed Mar. 1, 2024 and titled “Device for Rheo-Electric Measurements having a Low Thermal Impedance Guard,” the entirety of each of which is incorporated herein by reference.

### FIELD OF THE INVENTION

The disclosed technology relates generally to a device for measuring properties of materials. More particularly, the technology relates to a rheometer that mitigates stray capacitances while preserving a thermal conduction path from a temperature control device when measuring rheological properties of test samples.

### BACKGROUND

Rheometers are well-known for measure the relationships between stress and strain or strain rate by measuring the displacement, and more specifically torque, of a moving measurement in a finite sample volume defined by an upper and lower geometry, generally in the form of plates or the like, over a measured period of time. A temperature-controlled device may provide temperature control of samples undergoing testing by a rheometer. The lower geometry, e.g., bottom plate is generally constructed to have two conductive regions separated by an insulative region. The conductive regions include electrodes connected to a source, for example, a high potential and low potential connector, respectively.

Temperature control of a rheo-electric measurement device requires close proximity of the electrodes with environmental sources of capacitance, which transfer heat to or from a sample positioned at the sample volume between the upper and lower geometries. This undesirable stray capacitances between the electrodes and temperature-controlled thermal conductor can have a deleterious effect on electrical measurements. The stationary lower geometry generally includes an insulator, such as ceramic or polymer, for electrically insulating the two electrodes from the temperature-controlled thermal conductor. This may be an insulating coating with minimum thermal resistance to protect the insulator from the sample while providing the thermal conduction of heat to/from the sample plate from/to a temperature control device. One approach to reducing stray capacitance from the bottom geometry to a conductive surface is to increase the thickness of the insulator positioned between the thermally controlled conductor and electrodes in order to reduce the undesirable capacitance and to increase the thermal capacitance between the temperature controller and the sample surface. However, in doing so, the thermal resistance between the sample between the upper and lower geometries and the temperature controller also increases, which can negatively affect performance by slowing the temperature response and further degrade temperature control performance of the rheometer.

### SUMMARY

The present disclosure, in one aspect, describes an apparatus for performing electrical and rheology measurements of a material sample, comprising: an upper geometry; and a lower geometry. The lower geometry is stationary and the upper geometry rotates relative to the lower geometry. The lower geometry includes: a first electrode; a second electrode; and an electrical insulator for electrically isolating the first electrode from the second electrode. The apparatus further comprises a sample gap between the upper geometry and the lower geometry, the material sample positioned at the sample gap; a thermally conductive metal plate below the electrical insulator; and a layer of low thermal impedance conductive material and a layer of electrically insulating material between the electrical insulator and the thermally conductive metal plate for mitigating a source of stray capacitance from the traveling from the first and second electrodes to the thermally conductive metal plate and providing a desirable thermal conductance between the thermally conductive metal plate and uppermost surface of the lower geometry.

In another aspect, an apparatus for performing electrical and rheology measurements of a material sample comprises a plate comprising a first electrode; a second electrode; and an electrical insulator for electrically isolating the first electrode from the second electrode. The apparatus further comprises a thermally conductive metal plate below the electrical insulator; and a plurality of fastening devices extending from the first and second electrodes to the thermally conductive metal plate, the fastening devices constructed and arranged to not interfere with electrical properties of the lower geometry.

In another aspect, a measurement system comprises a rheometer, comprising: an upper geometry; and a lower geometry, wherein the lower geometry is stationary and the upper geometry rotates relative to the lower geometry. The lower geometry includes: a first electrode; a second electrode; and an electrical insulator for electrically isolating the first electrode from the second electrode, the rheometer further comprises a sample gap between the upper geometry and the lower geometry, the material sample positioned at the sample gap; a thermally conductive metal plate below the electrical insulator; and a layer of low thermal impedance conductive material and a layer of electrically insulating material between the electrical insulator and the thermally conductive metal plate. The system further comprises a meter electrically coupled to the first electrode, the second electrode, and the thermally conductive plate for measuring an inductance, capacitance, and resistance of the sample in the gap.

### BRIEF DESCRIPTION OF THE DRAWINGS

FIG. 1A is a perspective view of a rheometer.

FIG. 1B is a front view of the rheometer of FIG. 1A.

FIG. 2 is a perspective view of a rheometer, in accordance with some embodiments of the present inventive concept.

FIG. 3A is a perspective view of a rheometer, in accordance with other embodiments.

FIG. 3B is a cross-sectional view of the rheometer of FIG. 3A.

FIG. 4 depicts an electrical circuit of a rheometer of FIGS. 2 and 3.

FIG. 5A is a perspective view of a rheometer, in accordance with other embodiments.

FIG. 5B is a cross-sectional view of the rheometer of FIG. 5A.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

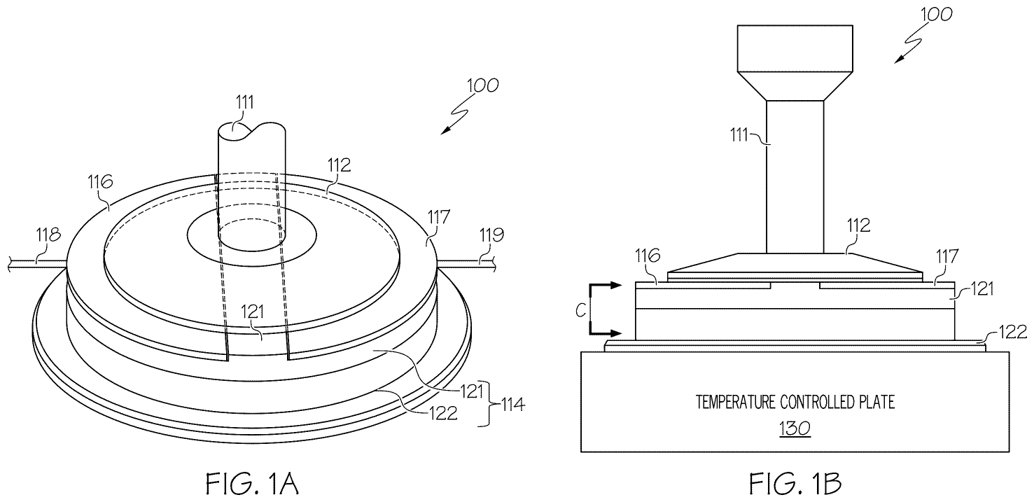

FIG. 1A is a perspective view of a rheometer 100 to which embodiments of the present inventive concept can be applied. FIG. 1B is a front view of the rheometer of FIG. 1A.

In some embodiments, the rheometer 100 is a parallel-geometry rheometer including a top plate 112 (also referred to as a first plate or upper geometry) and a bottom plate 114 (also referred to as a second plate or lower geometry), each having a specific predetermined geometry for performing measurements. In some embodiments, the top plate 112 and bottom plate 114 are Peltier plates. The rheometer 100 may have a drive shaft 111 that rotates the top plate 112 relative to the stationary bottom plate 114. During operation, a material sample (not shown) to be tested is placed between the plates 112, 114 which are separated by a gap having a known width. Here, the rheometer 100 measures the stress-strain relationship to understand the flow/deformation properties of the material sample. More specifically, measurements can be taken about the deformation properties of the material sample such as a rate of deformation, shear tension, and strain rate, allowing for an analysis of time-dependent behavior.

The bottom plate 114 has a first electrode 116, or first conductive region, and a second electrode 117, or second conductive region, for forming an electric field with the top plate 112 through the sample sandwiched between the top plate 112 and the bottom plate 114. The electrodes 116, 117 are separated by a thermally conductive insulator 121, such as ceramic, plastic, or other material having favorable heat dissipation and dielectric strength features. The thermally conductive insulator 121 provides the thermal conduction of heat to/from the sample plate from/to a temperature control device 130. The insulator 121 is preferably a thermally conductive material due to temperature control provided by the temperature control device 130. The temperature control device 130 can include a Peltier element, conductive or convention elements, or other well-known components for applying a change in temperature to the bottom plate 114. The insulator 121 can maintain isolation between the electrodes 116, 117, for example, by being mounted to a thermally conductive plate 122 forming at least part of the stationary bottom plate 114. The metal plate 122 may have two diameters, for example, hat-shaped as shown, but is not limited thereto.

The electrodes 116, 117 in the bottom plate 114 have opposite polarity voltages, and are isolated by the insulator 121 from each other so that one electrode 116 forms a potential across the sample gap to the top plate 112 and back to the other electrode 117. Each electrode 116, 117 can be connected to a source, for example, a high potential and low potential connector, respectively. In some configurations, the insulator 121 may at least partially cover the electrodes 116, 117 so that portions of the electrodes 116, 117 are exposed to the top plate 112. Conductive wires 118, 119 can extend from a voltage generator such as an LCR meter or other measurement device to the electrodes 116, 117, respectively. The permits the external source to apply an oscillating voltage to the electrodes 116, 117 and measure a current flow that can be used by a computer to determine the impedance in the sample gap.

A stray capacitance between the electrodes 116, 117 and the temperature control device 130 via a thermally conductive insulator layer 121 and a conductive layer 122 can contribute to error during an electrical measurement. For example, when a measurement signal is applied by an LCR meter or the like or the like to a sample via the conductive wires 118, 119 and electrodes 116, 117, respectively, a voltage difference will appear between the electrodes 118, 119 and temperature-controlled thermal conductor 122. This produces stray capacitances and allows the measurement signal to leak towards the conductive surface. Thus, the effect of stray capacitances results in a measurement error. The stray capacitances may result in a greater measurement error at a higher impedance range of the electrodes 116, 117 and at higher measurement frequencies.

In brief overview, embodiments and examples disclosed herein are directed to a measuring apparatus such as a rheometer or the like that includes a shielding plate and an electrically insulating layer between a sample under test and a conductive surface below the bottom plate of the rheometer, for example, between the thermally conductive insulator and conductive plate forming the bottom plate of a parallel-geometry rheometer, which maintain isolation between the electrodes and a conductive surface which also relies on a temperature control device to provide an insulative guard and in doing so, mitigate undesirable stray capacitances resulting in measurement errors. Thus, the shielding plate, or low thermal impedance guard, serves to protect against stray capacitances while also providing necessary heat transfer characteristics.

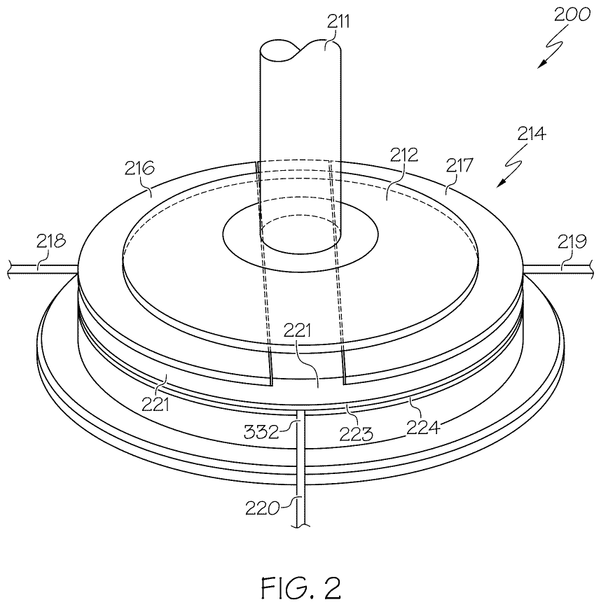

FIG. 2 is a perspective view of a rheometer 200, in accordance with some embodiments.

In some embodiments, the rheometer 200 is a parallel-geometry rheometer including a top plate 212 (also referred to as a first plate or upper geometry) and a bottom plate 214 (also referred to as a second plate or lower geometry), each having a specific predetermined geometry for performing measurements, similar to the rheometer 100 of FIGS. 1A and 1B. The rheometer 200 may have a drive shaft 211 that rotates the top plate 212 relative to the stationary bottom plate 214. The bottom plate 214 has a first electrode 216 and a second electrode 217 for forming an electric field with the top plate 212 through the sample sandwiched between the top plate 212 and the bottom plate 214. The electrodes 216, 217 are separated by a thermally conductive insulator 221, such as ceramic, plastic, or other material having favorable heat dissipation and dielectric strength features. The electrodes 216, 217 may be formed of a metal providing excellent mechanical and chemical resistance properties and can be electrically conductive. The thermally conductive insulator 221 provides the thermal conduction of heat to/from the sample plate from/to a temperature control device 230. The insulator 221 can maintain isolation between the electrodes 216, 217, for example, by being mounted to a thermally conductive plate 222 forming at least part of the stationary bottom plate 214. The insulator 221 may isolate the electrodes from themselves and from the apparatus, and may be formed of two portions to protect the ceramic from a sample. Positioned between the plates 212, 214. The thermally conductive plate 222 may be integral, or one piece and have two diameters, for example, a hat-shape having a bottom section with a diameter greater than a diameter of the top section as shown, but is not limited thereto. In some embodiments, the electrodes are not separable and the bottom plate 214 is directly mounted onto a temperature controlled plate, e.g., in the absence of a bayonet ring 222.

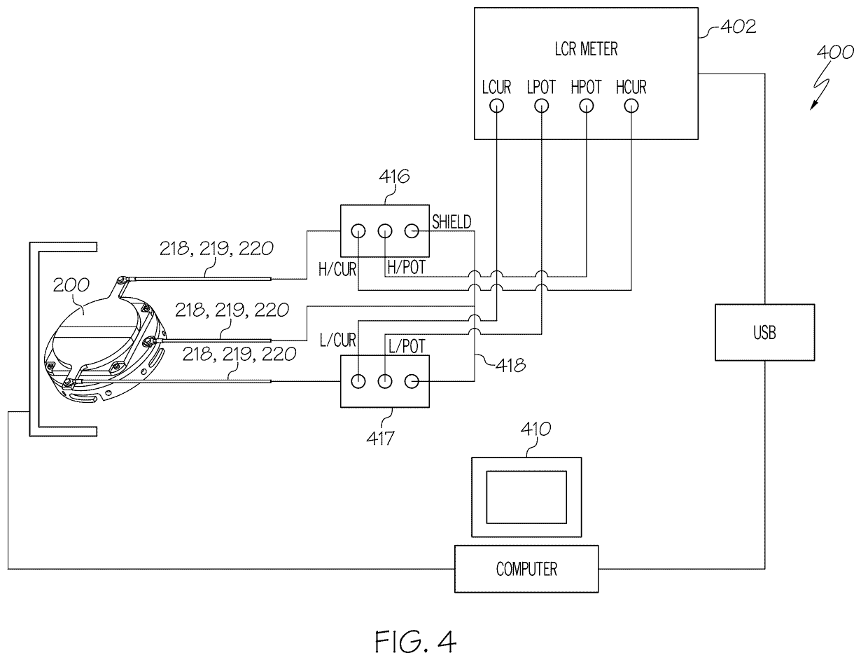

In some embodiments, the rheometer 200 includes a shielding plate 223 and an electrically insulating layer 224 between the thermally conductive insulator 221 and the thermally conductive plate 222 collectively forming the bottom plate 214 of the parallel-geometry rheometer. In some embodiments, the shielding plate 223 includes an electrical connector 332 to a ground component of the instrument, e.g., an LCR meter or the like, for example, shown in FIG. 4. In doing so, a leakage current flowing through stray capacitances that would otherwise be formed between the sample under test and a conductor, i.e., the conductive plate 222 in the absence of the shielding plate 223 is eliminated by the presence of the conductive plate 222. The electrically insulating layer 224 between the shielding plate 223 and the thermally conductive plate 222 provides a source of electrical insulation, or an additional insulation layer between the temperature-controlled plate and the electrodes so as to provide both thermally conductive and electrically insulative properties. In some embodiments, the insulating layer 224 is an anodized coating or polymer film or the like on a surface of the shielding plate 223 or the conductive plate 222 so that the insulating layer 224 is sandwiched between the shielding plate 223 or the conductive plate 222.

The electrodes 216, 217 in the bottom plate 214 have opposite polarity voltages, and are isolated by the insulator 221 from each other so that one electrode 216 forms a potential across the sample gap to the top plate 212 and back to the other electrode 217. Each electrode 216, 217 can be connected to a source, for example, a low potential (LPOT) 218 and high potential (HPOT) 219 connector, respectively. In some embodiments, one of the first and second electrodes is connected to a low potential voltage source and the other of the first and second electrodes is connected to a high potential voltage source, and wherein a voltage difference that yields a stray capacitance at a low side of the material sample having a potential of 0 volts is extinguished by a guard terminal coupled to the thermally conductive metal plate.

In some configurations, the insulator 221 may at least partially cover the electrodes 216, 217 so that portions of the electrodes 216, 217 are exposed to the top plate 212. Conductive wires 218, 219 can extend from a voltage generator such as an LCR meter or other measurement device to the electrodes 216, 217, respectively. The permits the external source to apply an oscillating voltage to the electrodes 216, 217 and measure a current flow that can be used by a computer to determine the impedance in the sample gap. Another conductive wire 220, referred to as a shield cable, is coupled to the shielding plate 223 by an electrical connector 332 such as a conductive screw.

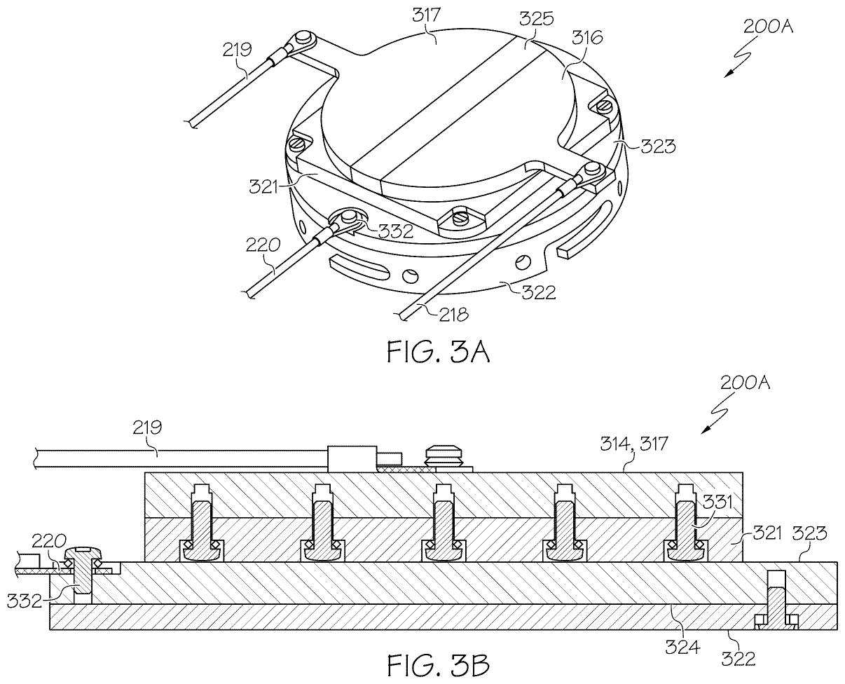

FIG. 3A is a perspective view of another rheometer 200A. FIG. 3B is a cutaway view of the rheometer 200A. The rheometer 200A, or more specifically, the bottom plate, includes components 316, 317, 323, 324 that are the same as or similar to the rheometer 200 of FIG. 2. Details of these components are not repeated for brevity. For example, the shielding plate 323 formed of aluminum or other low thermal impedance conductive material and electrically insulating layer 324 formed of a polymer film or anodized coating or the like are constructed and arranged to provide a guard against undesirable capacitances between the temperature controller 300 and the electrodes. Shown in FIGS. 3A and 3B is a mounting ring 322 on which the shielding plate 323 and insulating layer 324 are positioned. The mounting ring 322 can be a stainless steel bayonet ring that mounts onto a temperature controlled plate that is either brass, aluminum, copper, (could also be stainless steel or any other thermal conductor).

In addition, an insulator includes two portions, namely, a non-thermally conducting portion 325, e.g., formed of polyether ether ketone (PEEK) or the like, that bisects the electrodes 316, and 317 and a thermally conductive piece 321, e.g., formed of ceramic of the like, under both electrodes. This arrangement provides for better chemical compatibility with a sample, since the PEEK portion 325 is more inert than the thermally conductive portion 321 while still maintaining adequate temperature control since both electrodes are in good thermal communication with the temperature controller underneath via the ceramic portion, and equilibrates fairly well when heat flows around it from all sides. Accordingly, the electrical insulator can isolate the two electrodes from each other and the apparatus, e.g., temperature controlled plate, while maintaining good thermal conductance between the sample surface and temperature controller underneath. Here, the temperature control plate underneath is part of the rheometer itself, i.e., the apparatus.

In addition, the rheometer 200A includes a plurality of coupling elements 331 such as screws, bolts, or the like that are inserted into holes extending through the bottom of the thermally conductive insulator 321 and terminate in threaded holes in the electrode 317 of the bottom plate. Although not shown, the coupling elements 331 may be positioned circumferentially so as to also terminate in threaded holes in the other electrode 316.

As far as the low thermal impedance insulator, the low thermal impedance of the insulator could be achieved by a high thermal conductivity electrical insulator or a very thin film of non-conducting material. A thin film on the order of 0.001″ typically provides adequate electrical isolation while minimizing the thermal losses even if it's a poor conductor of heat (such as an anodized film or polymer coating).

FIG. 4 depicts an electrical circuit 400 of a rheometer for performing rheo-dielectric measurements in accordance with other embodiments of the present inventive concept. As shown in FIG. 4, connectors 416, 417 or other signal path elements are attached to the electrodes 216, 217 of the rheometer 200 of FIG. 2 or the electrodes 316, 317 of the rheometer 200A of FIG. 3, for example, described above. An impedance analyzer such as a LCR meter 402 is provided to induce an oscillating voltage via the terminal connectors 416, 417, or terminal blocks of the like, to the bottom plate 214, 314 and measuring the electrical response during operation of the rheometer, e.g., the top plate rotates relative to the bottom plate and the stress/strain relationship of a sample position in the gap between the plates is analyzed. As also shown, a ground path is formed from the shielding plate 223, 323 and a cable shielding 420 or other ground source of the LCR meter 302 that extends between the terminal blocks 416, 417. In some embodiments, the guard is isolated from the thermally conductive plate, where the plate is connected to the instrument ground. In other embodiments, the temperature controlled plate acts as the guard, e.g. directly connecting the temperature controlled plate to the LCR meter guard terminal.

The terminal blocks 416, 417 may each have a shield terminal, and the shield terminals may be electrically coupled by a connector 418 extending between them. The shield cable 220 may extend from the shielding plate 223 to the connector 418. A computer 410 can be in communication with the LCR meter 402 and the rheometer 200, 200A to process measurement data.

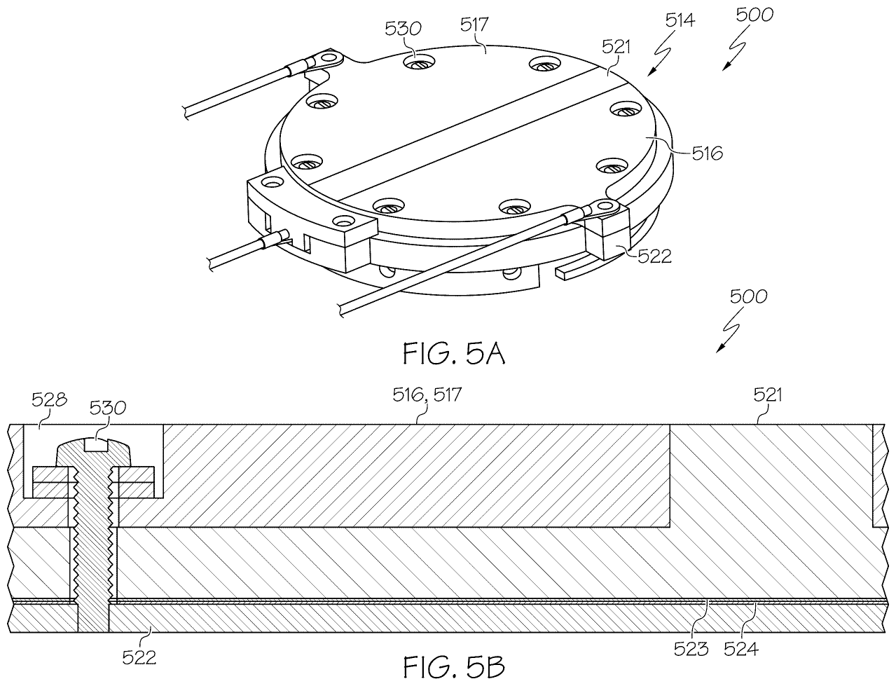

FIG. 5A is a perspective view of a rheometer 500, in accordance with other embodiments. FIG. 5B is a cross-sectional view of the rheometer of FIG. 5A. The rheometer 500, or more specifically, the bottom plate 514, includes components 516, 517, 521, 523, 524, etc. that are the same as or similar to the rheometer 200 of FIG. 2 or the rheometer 200A of FIGS. 3A and 3B. Details of these components are not repeated for brevity.

In addition, the rheometer includes a plurality of fastening device 530s, such as screws, bolts, and the like that each extend through a hole 528 in the electrodes 517, 518 for coupling the electrodes to the mounting ring 522, formed by example of stainless steel but not limited thereto. Although fastening devices 530 are shown as bolts, adhesives or the like may be used as fastening devices, or to complement the bolts or other shown fastening devices. Here, separate plating layers are parts that are bonded together, including an arrangement of conductive and non-conductive regions.

The rheometer 500 includes a plurality of vertical paths formed by openings in the electrodes 516, 517, the thermally conductive insulator layer 521, shielding plate 523, insulating layer 524, and mounting ring 522 respectively. The fastening devices 530 are inserted through the openings forming the path to terminate, e.g., thread, into threaded apertures in the mounting ring 522. The fastening devices 530 are configured to not interfere with the electrical properties of the rheometer 500.

With regard to the foregoing, reference is made to guards and electrodes implemented as “plates.” In some embodiments, a plate can be constructed and arranged as a unitary structure by layering coatings on top of the temperature controlled plate. For example, a construction may include the formation of a structure by anodizing the plate (insulating), applying a metal plating on top of the guard, applying a spray on adhesive or polymer coating on top of the sputtered metal, and then plate two electrodes on top of the polymer coating. Anywhere there is a separate machined part could be replaced by a coating process.

What is claimed is:

1. An apparatus for performing electrical and rheology measurements of a material sample, comprising:
an upper geometry; and
a lower geometry, wherein the lower geometry is stationary and the upper geometry rotates relative to the lower geometry, and wherein the lower geometry includes:
a first electrode;
a second electrode; and
an electrical insulator for electrically isolating the first electrode from the second electrode, the apparatus further comprising:
a sample gap between the upper geometry and the lower geometry, the material sample positioned at the sample gap;
a thermally conductive metal plate below the electrical insulator; and
a layer of low thermal impedance conductive material and a layer of electrically insulating material between the electrical insulator and the thermally conductive metal plate for mitigating a source of stray capacitance from the traveling from the first and second electrodes to the thermally conductive metal plate and providing a desirable thermal conductance between the thermally conductive metal plate and uppermost surface of the lower geometry.

2. The apparatus of claim 1, further comprising a temperature control apparatus below the thermally conductive metal plate that exchanges a thermal conduction with the lower geometry.

3. The apparatus of claim 2, wherein the layer of low thermal impedance conductive material provides a capacitance preventing guard between the temperature control device and the first and second electrodes by being positioned between the electrical insulator and the layer of electrically insulating material.

4. The apparatus of claim 2, wherein the electrical insulator maintains a desirable thermal conductance between a surface on which the material sample is positioned and the temperature control apparatus.

5. The apparatus of claim 1, further comprising a plurality of fastening devices extending from the first and second electrodes to the thermally conductive metal plate, the fastening devices constructed and arranged to not interfere with electrical properties of the lower geometry.

6. The apparatus of claim 1, wherein the layer of electrically insulating material includes an anodized coating.

7. The apparatus of claim 1, wherein the layer of electrically insulating material includes a thin film polymer insulation.

8. The apparatus of claim 1, wherein the low thermal impedance conductive material is coupled to a ground of an instrument.

9. The apparatus of claim 1, wherein the instrument measures an inductance, capacitance, and resistance of the sample in the gap.

10. The apparatus of claim 1, wherein one of the first and second electrodes is connected to a low potential voltage source and the other of the first and second electrodes is connected to a high potential voltage source, and wherein a voltage difference that yields a stray capacitance at a low side of the material sample having a potential of 0 volts is extinguished by a guard terminal coupled to the thermally conductive metal plate.

11. The apparatus of claim 1, wherein the thermally conductive metal plate includes a stainless steel bayonet ring that mounts onto a temperature controller.

12. The apparatus of claim 1, wherein the insulator includes a non-thermally conducting portion between the first and second electrodes and a thermally conductive portion under the first and second electrodes.

13. The apparatus of claim 12, wherein non-thermally conducting portion is formed of polyether ether ketone (PEEK) and the thermally conductive portion is formed of ceramic.

14. An apparatus for performing electrical and rheology measurements of a material sample, comprising:
a plate comprising:
a first electrode;
a second electrode; and
an electrical insulator for electrically isolating the first electrode from the second electrode, the apparatus further comprising:
a thermally conductive metal plate below the electrical insulator; and
a plurality of fastening devices extending from the first and second electrodes to the thermally conductive metal plate, the fastening devices constructed and arranged to not interfere with electrical properties of the lower geometry.

15. The apparatus of claim 14, further comprising:
a layer of low thermal impedance conductive material and a layer of electrically insulating material between the electrical insulator and the thermally conductive metal plate, wherein the plurality of fastening devices extend through the a layer of low thermal impedance conductive material and a layer of electrically insulating material.

16. The apparatus of claim 14, wherein the first and second electrodes, the layer of low thermal impedance conductive material, the layer of electrically insulating material, and the thermally conductive metal plate each includes a hole corresponding to each of the fastening devices, and wherein a first hole of one of the first and second electrodes is vertically aligned with a first hole of the low thermal impedance conductive material, a first hole of the layer of electrically insulating material, and a first hole of the thermally conductive metal plate for receiving one of the fastening devices.

17. A measurement system, comprising:
a rheometer, comprising:
an upper geometry; and
a lower geometry, wherein the lower geometry is stationary and the upper geometry rotates relative to the lower geometry, and wherein the lower geometry includes:
a first electrode;
a second electrode; and
an electrical insulator for electrically isolating the first electrode from the second electrode, the rheometer further comprising:
a sample gap between the upper geometry and the lower geometry, the material sample positioned at the sample gap;
a thermally conductive metal plate below the electrical insulator; and
a layer of low thermal impedance conductive material and a layer of electrically insulating material between the electrical insulator and the thermally conductive metal plate, the system further comprising:
a meter electrically coupled to the first electrode, the second electrode, and the thermally conductive plate for measuring an inductance, capacitance, and resistance of the sample in the gap.

18. The system of claim 17, wherein one of the first and second electrodes is connected to a low potential voltage source and the other of the first and second electrodes is connected to a high potential voltage source, and wherein a voltage difference that yields a stray capacitance at a low side of the material sample having a potential of 0 volts is extinguished by a guard terminal coupled between the thermally conductive metal plate and the meter.

19. The system of claim 17, wherein the low thermal impedance conductive material is coupled to a ground, wherein a temperature controlled apparatus is connected to a guard terminal of the meter.

20. The system of claim 17, wherein the layer of low thermal impedance conductive material is isolated from the thermally conductive plate.
